(19) United States
(12) Patent Application Publication
(10) Pub. No.: US 2026/0233614 A1
(43) Pub. Date: Aug. 13, 2026

(54) FUEL CELL VEHICLE AND METHOD OF OPERATING THE SAME

(71) Applicants: HYUNDAI MOTOR COMPANY, SEOUL (KR); KIA CORPORATION, SEOUL (KR)

(72) Inventors: Tae Hyun Chun, Hwaseong-si (KR); Myung Jin Kim, Hwaseong-si (KR); Hye Bin Park, Hwaseong-si (KR); Min Gyu Kang, Hwaseong-si (KR); Jin Young Kim, Hwaseong-si (KR); Gi Young Nam, Hwaseong-si (KR); Hee Tae Park, Hwaseong-si (KR)

(73) Assignees: HYUNDAI MOTOR COMPANY, SEOUL (KR); KIA CORPORATION, SEOUL (KR)

(21) Appl. No.: 19/228,103

(22) Filed: Jun. 4, 2025

(30) Foreign Application Priority Data
Feb. 10, 2025 (KR) 10-2025-0016747

(51) Int. Cl. B60L 1/12; B60L 50/70; H01M 8/04303; H01M 8/04701

(52) U.S. Cl. CPC B60L 1/12; B60L 50/70; H01M 8/04303; H01M 8/04716; B60L 2240/36

(57) ABSTRACT

A fuel cell vehicle includes: a fuel cell generating a stack voltage; a battery outputting a low voltage that is lower than the stack voltage; a cathode oxygen depletion (COD) heater increasing the temperature of residual water generated from the fuel cell in response to the stack voltage; a power distribution unit supplying the stack voltage to the COD heater; a fuel cell control unit including a diode having a cathode connected to the low voltage and a anode connected to the power distribution unit; and a start-up inspection unit determining whether to supply the low voltage to the COD heater based on a result of inspecting whether the vehicle is powered off. The power distribution unit includes an auxiliary relay configured to be energized when the low voltage is applied and a main relay supplying the stack voltage to the COD heater when the auxiliary relay is energized.

### CROSS-REFERENCE TO RELATED APPLICATION(S)

This application claims the benefit of and priority to Korean Patent Application No. 10-2025-0016747, filed on Feb. 10, 2025, the entire contents of which are incorporated herein by reference.

### BACKGROUND

### (A) Technical Field

The present disclosure relates to a fuel cell vehicle and a method of operating the same.

### (B) Background Art

In general, as a result of power generation using hydrogen and oxygen in a fuel cell, water (hereinafter referred to as residual water) may be generated and remain in each of a plurality of unit cells. A vehicle including a fuel cell may be exposed to various external environments. When the vehicle is exposed to a low-temperature environment for a long time period, residual water remaining in each unit cell may freeze. In addition, when the residual water is discharged without increase in the temperature thereof after power-off of the vehicle, the residual water may be discharged in a small amount or may freeze. Due to expansion of the residual water caused by freezing, surface pressure of certain areas in the plurality of unit cells increases, and thus irreversible plastic deformation occurs in a gas diffusion layer and a separator among the internal components of the unit cell. As a result, the performance and durability of the cell stack composed of the plurality of unit cells may deteriorate.

In order to effectively discharge residual water while preventing freezing thereof, a cathode oxygen depletion (COD) heater may be used in order to increase the temperature of the residual water. However, when a relay disposed between the stack and the COD heater is turned on/off during application of current, a high-temperature arc may occur between contact portions, causing the relay to be fused. Thus, it is not possible to operate the COD heater to prevent freezing of the residual water.

### SUMMARY

Accordingly, embodiments are directed to a fuel cell vehicle and a method of operating the same that substantially obviate one or more technical problems due to limitations and disadvantages of the related art.

Embodiments provide a fuel cell vehicle capable of increasing the temperature of residual water using a cathode oxygen depletion (COD) heater after power-off of the vehicle and a method of operating the same.

However, the objects to be accomplished by the embodiments are not limited to the above-mentioned objects, and other objects not mentioned herein should be clearly understood by those having ordinary skill in the art from the following description.

Additional advantages, objects, and features of the disclosure are set forth in part in the description which follows and in part should become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A fuel cell vehicle according to an embodiment may include: a fuel cell configured to generate a stack voltage; a battery configured to output a low voltage having a lower level than the stack voltage; and a cathode oxygen depletion (COD) heater configured to increase the temperature of residual water generated from the fuel cell in response to the stack voltage. The fuel cell vehicle may also include: a power distribution unit configured to supply the stack voltage to the COD heater; a fuel cell control unit including a diode having a cathode connected to the low voltage and a anode connected to the power distribution unit; and a start-up inspection unit configured to determine whether to supply the low voltage to the COD heater based on a result of inspecting whether the fuel cell vehicle is powered off. The power distribution unit may include an auxiliary relay configured to be energized when the low voltage is applied thereto and a main relay configured to supply the stack voltage to the COD heater when the auxiliary relay is energized.

In an example, the main relay may include: a first junction portion disposed between the stack voltage and the COD heater; and a first coil portion including a first end connected to the auxiliary relay and a second end connected to a reference potential. The auxiliary relay may include: a second junction portion disposed between the low voltage and the first end of the first coil portion; and a second coil portion disposed between the low voltage and the anode of the diode. The second junction portion may be turned on when the low voltage is applied to the second coil portion, and when the low voltage is applied to the first end of the first coil portion through the second junction portion. The first junction portion may be energized to supply the stack voltage to the COD heater.

In an example, the fuel cell vehicle may further include a voltage switch including a first end connected to the battery and a second end connected to the second coil portion. The voltage switch is configured to connect the battery to the second end of the second coil portion in response to a control signal. The start-up inspection unit may generate the control signal based on the result of inspecting whether the fuel cell vehicle is powered off.

In an example, the cathode of the diode may be connected to the first end of the voltage switch.

In an example, the cathode of the diode may be connected to the second end of the voltage switch.

In an example, the power distribution unit may include the voltage switch.

In an example, the battery may apply the low voltage to the second coil portion in response to a control signal, and the start-up inspection unit may be configured to generate the control signal based on the result of inspecting whether the fuel cell vehicle is powered off.

In an example, the reference potential may correspond to a ground of a housing of the power distribution unit.

In an example, the reference potential may correspond to a ground of the fuel cell control unit itself.

In an example, the power distribution unit may further include a pyro fuse disposed between the stack voltage and the first junction portion.

In an example, the power distribution unit may further include an integrated relay connected between the stack voltage and each of an end cell heater and the first junction portion.

In an example, the COD heater may include a resistor including a first end connected to a positive output terminal of the fuel cell and a switching element including a first end connected to the second end of the resistor and a second end connected to the first junction portion. The first junction portion may be connected between a negative output terminal of the fuel cell and the second end of the switching element.

In an example, the COD heater may include first to N^{th} (N being a positive integer of 2 or greater) resistors connected in parallel to each other and first to N^{th} switching elements connected to the first to N^{th} resistors, respectively. The n^{th} (1≤n≤N) resistor may include a first end connected to a positive output terminal of the fuel cell, and the n^{th} switching element may be connected between a second end of the n^{th} resistor and the first junction portion.

According to another embodiment, a method of operating a fuel cell vehicle is provided. The fuel cell vehicle includes: a fuel cell configured to generate a stack voltage; a battery configured to output a low voltage having a lower level than the stack voltage; a cathode oxygen depletion (COD) heater; a power distribution unit including an auxiliary relay disposed between the low voltage and the COD heater and a main relay disposed between the auxiliary relay and the COD heater; and a fuel cell control unit including a diode having a cathode connected to the low voltage and an anode connected to the power distribution unit. The method may include: inspecting whether the fuel cell vehicle is powered off; energizing the main relay through the auxiliary relay to supply the stack voltage to the COD heater when it is determined that the fuel cell vehicle has been powered off; and increasing the temperature of residual water generated from the fuel cell when the stack voltage is supplied.

In an example, the main relay may include: a first junction portion disposed between the stack voltage and the COD heater; and a first coil portion including a first end connected to the auxiliary relay and a second end connected to a reference potential. The auxiliary relay may include: a second junction portion disposed between the low voltage and the first end of the first coil portion and a second coil portion disposed between the low voltage and the anode of the diode. Supplying the stack voltage may include: applying the low voltage to the second coil portion to energize the second junction portion when it is determined that the fuel cell vehicle has been powered off; and energizing the first junction portion to supply the stack voltage to the COD heater when the low voltage is applied to the first coil portion through energization of the second junction portion.

In an example, the method may further include not applying the low voltage to the second coil portion upon completion of the residual water heating.

It should be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell vehicle according to an embodiment;

FIG. 2 is a circuit diagram of another embodiment of the power distribution unit shown in FIG. 1;

FIG. 3 is a circuit diagram of still another embodiment of the power distribution unit shown in FIG. 1;

FIG. 4 is a circuit diagram of still another embodiment of the power distribution unit shown in FIG. 1;

FIG. 5 is a circuit diagram of still another embodiment of the power distribution unit shown in FIG. 1;

FIGS. 6A and 6B are circuit diagrams of fuel cell vehicles according to other embodiments;

FIG. 7 is a flowchart explaining a method of operating a fuel cell vehicle according to an embodiment;

FIG. 8 is a block diagram of a fuel cell vehicle according to a comparative example;

FIGS. 9A to 9C are waveform diagrams explaining operation of a fuel cell vehicle according to the comparative example shown in FIG. 8;

FIG. 10A is a diagram showing a state in which a current flows through a coil portion when the junction portion shown in FIG. 8 is in an on state;

FIG. 10B is a diagram showing a state in which the junction portion is turned off after a current flows through a coil portion shown in FIG. 8 for a predetermined time period;

FIGS. 11A to 11F are waveform diagrams explaining operation of the fuel cell vehicle according to the embodiment shown in FIG. 2;

FIG. 12A is a diagram showing a state in which a current flows through first and second coil portions when first and second junction portions shown in FIG. 2 are in an on state;

FIG. 12B is a diagram showing a state in which a first junction portion is turned off after a current flows through a second coil portion shown in FIG. 2 for a predetermined time period and then flows through a first coil portion for a predetermined time period; and

FIGS. 13A and 13B are graphs showing a number of switching operations based on a capacity of a relay.

### DETAILED DESCRIPTION

The present disclosure is described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure is be more thorough and complete, and should more fully convey the scope of the disclosure to those having ordinary skill in the art.

It should be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.
When a controller, component, device, element, part, unit, module, or the like of the present disclosure is described as having a purpose or performing an operation, function, or the like, the controller, component, device, element, part, unit, or module should be considered herein as being “configured to” meet that purpose or perform that operation or function. Each controller, component, device, element, part, unit, module, and the like may separately embody or be included with a processor and a memory, such as a non-transitory computer-readable media, as part of the apparatus.

Hereinafter, fuel cell vehicles 100A to 100C according to embodiments is described with reference to the accompanying drawings.

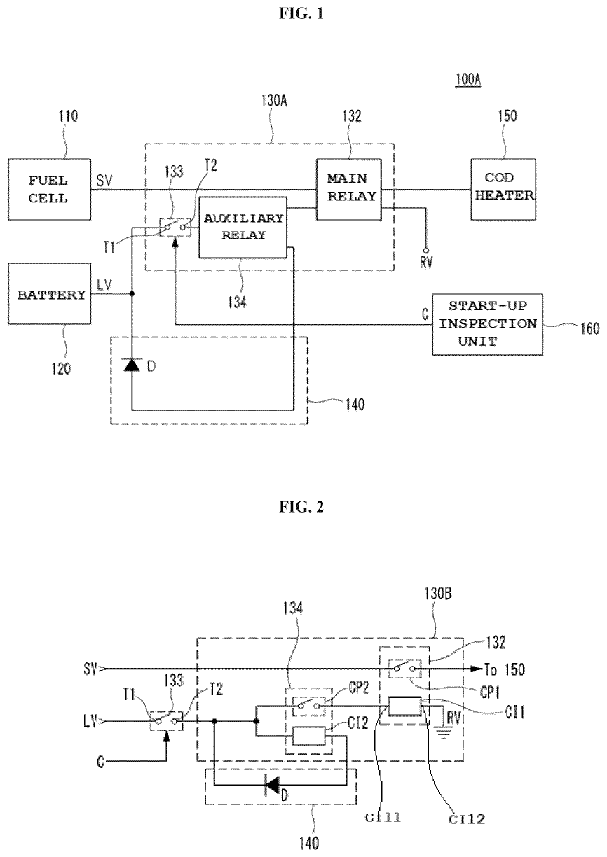

FIG. 1 is a block diagram of a fuel cell vehicle 100A according to an embodiment.

The fuel cell vehicle 100A shown in FIG. 1 may include a fuel cell 110, a battery 120, a power distribution unit (PDU) (a high-voltage junction box or a junction box) 130A, a fuel cell control unit (FCU) 140, a cathode oxygen depletion (COD) heater 150, and a start-up inspection unit (or a low-voltage supply control unit) 160.

The fuel cell 110 may generate a stack voltage SV using hydrogen and oxygen. As a result of power generation, water (product water or condensate) (hereinafter referred to as “residual water”) may be generated and remain. The fuel cell 110 may include a plurality of unit fuel cells stacked in at least one of a vertical direction or a horizontal direction. A unit fuel cell may be a polymer electrolyte membrane fuel cell (or a proton exchange membrane fuel cell) (PEMFC), which has been studied most extensively as a power source for driving fuel cell vehicles. However, the embodiments are not limited to any specific form, configuration, or appearance of the unit fuel cell.

A unit fuel cell included in the fuel cell 110 may include end plates (pressing plates or compression plates) (not shown), current collectors (not shown), and a cell stack (not shown).

The cell stack may include a plurality of unit cells stacked in the horizontal direction. Tens to hundreds of unit cells, e.g., 100 to 400 unit cells, may be stacked to form the cell stack. The number of unit fuel cells included in the fuel cell 110 and the number of unit cells included in the cell stack of the unit fuel cell may be determined based on the intensity of power to be supplied from the fuel cell 110 to a load (not shown).

The end plates may be disposed at respective ends of the cell stack and may support and fix the plurality of unit cells. In other words, one of the end plates may be disposed at one of the two opposite ends of the cell stack, and the other of the end plates may be disposed at the other of the two opposite ends of the cell stack.

In addition, the fuel cell 110 may further include a clamping member (not shown), which has a bar shape, a long bolt shape, a belt shape, or a rigid rope shape to clamp the plurality of unit cells. For example, in each unit fuel cell, the clamping member serves to clamp the plurality of unit cells in the horizontal direction together with the end plates.

The battery 120 outputs a voltage (hereinafter referred to as a “low voltage”) LV having a lower level than the stack voltage SV. For example, the level of the stack voltage SV may be 60 volts to 300 volts, and the level of the low voltage LV may be 12 volts. However, the embodiments are not limited to any specific level of the stack voltage SV or the low voltage LV.

The COD heater 150 may serve to eliminate voltage using a resistor (i.e., a heat generator) as an oxygen removal device in an oxygen electrode in order to prevent deterioration of the cell stack. In addition, the COD heater 150 may heat coolant without wasting thermal energy from the heat generator during start-up of the vehicle and may use the heated coolant to preheat the cell stack. In addition, according to the embodiment, the COD heater 150 may serve to increase the temperature of the residual water generated in the fuel cell 110. For example, the COD heater 150 may operate when the stack voltage SV is applied, thereby increasing the temperature of the residual water.

The fuel cell control unit 140 may include a feedback circuit connected to the low voltage LV and the power distribution unit 130A. For example, the feedback circuit may include a diode D having a cathode connected to the low voltage LV and an anode connected to the power distribution unit 130A. Although the fuel cell control unit 140 is shown in FIG. 1 as including only the diode D, the fuel cell control unit 140 serves to control the overall operation of the fuel cell 110.

The start-up inspection unit 160 may inspect whether the fuel cell vehicle 100A is started up or powered off, and may determine whether to supply the low voltage LV to the COD heater 150 based on a result of the inspection.

Although the start-up inspection unit 160 and the fuel cell control unit 140 are shown in FIG. 1 as being provided separately from each other, the start-up inspection unit 160 may be included in the fuel cell control unit 140.

The power distribution unit 130A may serve to receive power generated from the fuel cell 110 through a terminal block (not shown) and to distribute the received power to a peripheral high-voltage part (e.g., a load of the vehicle) for operating the fuel cell vehicle 100A through a voltage cable. According to the embodiment, the power distribution unit 130A may supply the stack voltage SV to the COD heater 150.

According to the embodiment, the power distribution unit 130A may include a main relay (or a COD heater relay) 132 and an auxiliary relay 134.

The auxiliary relay 134 may be energized when the low voltage LV is applied thereto, and may be disposed between the battery 120 and the main relay 132.

The main relay 132 may be disposed between the stack voltage SV and the COD heater 150, and may be energized when the auxiliary relay 134 is energized, thereby supplying the stack voltage SV to the COD heater 150.

FIG. 2 is a circuit diagram of another embodiment 130B of the power distribution unit 130A shown in FIG. 1.

The power distribution unit 130A shown in FIG. 1 includes the main relay 132, the auxiliary relay 134, and the voltage switch 133, while the power distribution unit 130B shown in FIG. 2 includes only the main relay 132 and the auxiliary relay 134. With this exception, the power distribution unit 130A shown in FIG. 1 has the same configuration as the power distribution unit 130B shown in FIG. 2.

The main relay 132 may include a first junction portion (or a first contact portion) CP1 and a first coil portion CI1.

The first junction portion CP1 may be disposed between the stack voltage SV and the COD heater 150. The first coil portion CI1 may include an end CI11 (e.g., first end) connected to the auxiliary relay 134 and another end CI12 (e.g., second end) connected to a reference potential RV.

The auxiliary relay 134 may include a second junction portion (or a second contact portion) CP2 and a second coil portion CI2.

The second junction portion CP2 may be disposed between the low voltage LV and one end of the first coil portion CI1, and the second coil portion CI2 may be disposed between the low voltage and the fuel cell control unit 140, i.e., the anode of the diode D.

For example, the second junction portion CP2 may be turned on (connected or energized) when the low voltage LV is applied to the second coil portion CI2. In this case, the second junction portion CP2 may be energized when the low voltage LV is applied to the second coil portion CI2, thereby applying the low voltage LV to the first coil portion CI1.

The first junction portion CP1 may be turned on (connected or energized) when the low voltage LV is applied to one end of the first coil portion CI1 through the second junction portion CP2, thereby supplying the stack voltage SV to the COD heater 150.

According to the embodiment, the configuration for supplying the low voltage LV to the COD heater 150 based on start-up or power-off of the fuel cell vehicle 100A may vary.

According to the embodiment, as shown in FIG. 1, the power distribution unit 130A may include a voltage switch 133.

The voltage switch 133 may have an end (e.g., first end) T1 connected to the battery 120 and another end (e.g., second end) T2 connected to the auxiliary relay 134 (i.e., the second coil portion CI2 shown in FIG. 2), and may connect the battery 120 to the other end of the second coil portion CI2 in response to a control signal C. To this end, the start-up inspection unit 160 generates a control signal C based on a result of inspecting whether the vehicle 100A is started up or powered off.

In other words, when it is determined that the vehicle has been powered off, the voltage switch 133 is turned on in response to the control signal C generated from the start-up inspection unit 160, and the low voltage LV output from the battery 120 is applied to the second coil portion CI2, so that the second junction portion CP2 may be energized.

Unlike the configuration in FIG. 2 in which the voltage switch 133 is disposed outside the power distribution unit 130A shown in FIG. 1, the voltage switch 133 may be disposed inside the power distribution unit 130A shown in FIG. 1.

In the configuration in FIG. 1, the cathode of the diode D may be connected to the end T1 of the voltage switch 133, while in the configuration in FIG. 2, the cathode of the diode D may be connected to the other end T2 of the voltage switch 133.

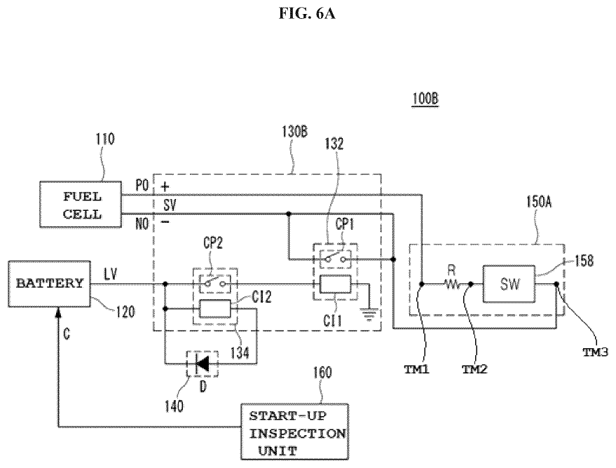

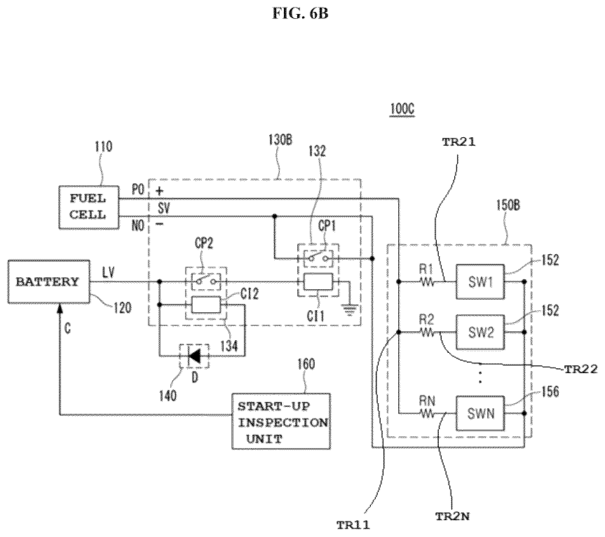

According to another embodiment, as shown in FIG. 6A described below, the battery 120 may apply the low voltage LV to the second coil portion CI2 in response to the control signal C. To this end, the start-up inspection unit 160 generates the control signal C based on a result of inspecting whether the vehicle is started up or powered off, and outputs the control signal C to the battery 120.

In other words, when it is determined that the vehicle has been powered off, the battery 120 may apply the low voltage LV to the second coil portion CI2 in response to the control signal C generated from the startup inspection unit 160, so that the second junction portion CP2 may be energized.

According to still another embodiment, unlike the configuration shown in FIG. 2, the startup inspection unit 160 may receive the low voltage LV from the battery 120, and may directly apply the low voltage LV to the second coil portion CI2 when it is determined that the vehicle has been powered off.

In the configuration in which whether the low voltage LV is generated from the battery 120 in response to the control signal C is determined, the voltage switch 133 shown in FIGS. 1 and 2 may be omitted.

Hereinafter, the fuel cell vehicle 100A is described based on the configuration in which the voltage switch 133 is disposed inside or outside the power distribution unit. However, the following description of the configuration of the fuel cell vehicle 100A, except the voltage switch 133, may also be applied to a configuration in which the voltage switch 133 is omitted and the low voltage LV is output from the battery 120 in response to the control signal C or is output from the startup inspection unit 160.

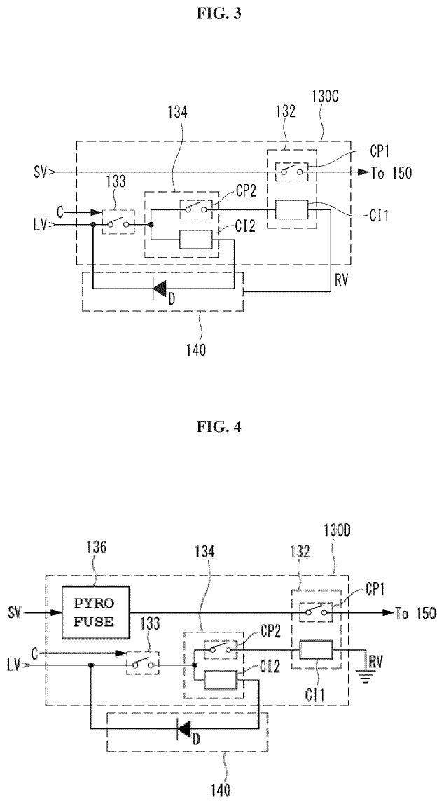

FIG. 3 is a circuit diagram of still another embodiment 130C of the power distribution unit 130A shown in FIG. 1.

The reference potential RV connected to the first coil portion CI1 shown in FIG. 2 corresponds to a ground of a housing (not shown) of the power distribution unit 130B. In other words, the first coil portion CI1 is connected to the ground of the housing of the power distribution unit 130B.

Alternatively, the reference potential RV connected to the first coil portion CI1 shown in FIG. 3 may correspond to a ground of the fuel cell control unit 140 itself. In other words, the first coil portion CI1 may be connected to the ground of the fuel cell control unit 140 itself.

In this way, the power distribution unit 130C shown in FIG. 3 is the same as the power distribution unit 130B shown in FIG. 2, with the exception that there is a difference in the reference potential RV connected to the other end of the first coil portion CI1 and there is a difference in the placement position of the voltage switch 133, and thus duplicate descriptions thereof have been omitted.

FIG. 4 is a circuit diagram of still another embodiment 130D of the power distribution unit 130A shown in FIG. 1.

Unlike the power distribution unit 130B shown in FIG. 2, the power distribution unit 130D shown in FIG. 4 further includes a pyro fuse 136. Further, the placement position of the voltage switch 133 is different from that in the power distribution unit 130B shown in FIG. 2. With this exception, the power distribution unit 130D shown in FIG. 4 is the same as the power distribution unit 130B shown in FIG. 2, and thus duplicate descriptions of the same parts have been omitted.

The pyro fuse 136 may be disposed between the stack voltage SV and the first junction portion CP1. The pyro fuse 136 activates when the main relay 132 is fused, thereby enhancing the safety level of the power distribution unit 130D.

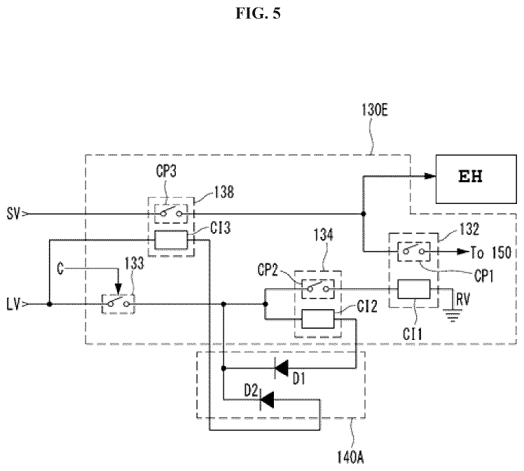

FIG. 5 is a circuit diagram of still another embodiment 130E of the power distribution unit 130A shown in FIG. 1.

Unlike the power distribution unit 130B shown in FIG. 2, the power distribution unit 130E shown in FIG. 5 further includes an integrated relay 138. Further, the placement position of the voltage switch 133 and the configuration of the fuel cell control unit 140A are different from those in the power distribution unit 130B shown in FIG. 2. With this exception, the power distribution unit 130E shown in FIG. 5 is the same as the power distribution unit 130B shown in FIG. 2, and thus duplicate descriptions of the same parts have been omitted.

The integrated relay 138 includes a third junction portion CP3 and a third coil portion CI3. The third junction portion CP3 is connected between the stack voltage SV and each of an end cell heater EH and the first junction portion CP1, and the third coil portion CI3 is disposed between the low voltage LV and the fuel cell control unit 140A.

The fuel cell control unit 140A includes first and second diodes D1 and D2. The first diode D1 performs the same function as the diode D shown in FIG. 2. The second diode D2 has a cathode connected to the low voltage LV and an anode connected to the third coil portion CI3.

A fuel cell vehicle generally includes a relay for an end cell heater. According to the embodiment, the integrated relay 138 plays a role of the relay for the end cell heater and also performs a function of interrupting the supply of the stack voltage SV to the main relay 132 when the main relay 132 is fused. In other words, due to the configuration shown in the drawing, when the integrated relay 138 is de-energized, the supply of stack voltage SV to the end cell heater EH and the main relay 132 may be interrupted even when the main relay 132 is fused. In this way, the integrated relay 138 plays a role of the relay for the end cell heater EH and performs a function of enhancing the safety level for performance of function of the main relay 132 in an integrated manner.

FIGS. 6A and 6B are circuit diagrams of fuel cell vehicles 100B and 100C according to other embodiments.

Each of the fuel cell vehicles 100B and 100C may include a fuel cell 110, a battery 120, a power distribution unit 130B, a fuel cell control unit 140, a COD heater 150A, and a start-up inspection unit 160.

Unlike the fuel cell vehicle 100A shown in FIGS. 1 and 2, the voltage switch 133 is omitted, the low voltage LV is output from the battery 120 in response to the control signal C, and the detailed configuration of the COD heater 150A is illustrated. With this exception, the fuel cell vehicles 100B and 100C shown in FIGS. 6A and 6B are the same as the fuel cell vehicle 100A shown in FIGS. 1 and 2, and thus, duplicate descriptions of the same parts have been omitted.

Referring to FIG. 6A, the COD heater 150A may include a resistor R and a switching element (SW) 158.

The resistor R has an end TM1 (e.g., first end) connected to a positive output terminal PO of the fuel cell 110, and another end TM2 (e.g., second end). The switching element (SW) 158 has an end TM2 (e.g., first end) connected to the other end of the resistor R and another end TM3 (e.g., second end) connected to the first junction portion CP1. In this case, the first junction portion CP1 may be connected between a negative output terminal NO of the fuel cell 110 and the other end of the switching element (SW) 158.

A potential difference between the positive output terminal PO and the negative output terminal NO of the fuel cell 110 corresponds to the stack voltage SV.

Referring to FIG. 6B, the COD heater 150B may include first to N^{th} resistors R1 to RN and first to N^{th} switching elements 152 to 156. N is a positive integer of 2 or greater.

The first to N^{th} resistors R1 to RN may be connected in parallel to each other, and the first to N^{th} switching elements (SW1 to SWN) 152 to 156 may be connected to the first to N^{th} resistors R1 to RN, respectively. In other words, the n^{th} resistor Rn has an end TR11 (e.g., first end) connected to the positive output terminal PO of the fuel cell 110 and another end TR2n (e.g., second end) connected to the n^{th} switching element SWn. Here, 1≤n≤N.

The n^{th} switching element SWn is connected between the other end of the n^{th} resistor Rn and the first junction portion CP1.

In the fuel cell vehicles 100B and 100C shown in FIGS. 6A and 6B, the main relay 132 may be used when the switching element SW or the switching elements SW1 to SWN malfunction.

Hereinafter, a method of operating the fuel cell vehicle according to an embodiment is described with reference to the accompanying drawings.

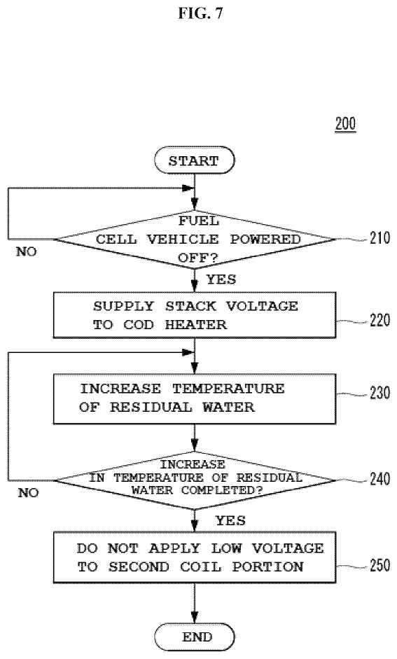

FIG. 7 is a flowchart explaining a method 200 of operating a fuel cell vehicle according to an embodiment.

According to the embodiment, whether the fuel cell vehicle is powered off is inspected (step 210). Step 210 may be performed by the start-up inspection unit 160.

When it is determined that the fuel cell vehicle has been powered off, the main relay 132 may be energized through the auxiliary relay 134 to supply the stack voltage SV to the COD heater 150 (step 220).

For example, upon determining that the fuel cell vehicle has been powered off, the start-up inspection unit 160 supplies the low voltage LV stored in the battery 120 to the auxiliary relay 134. To this end, the start-up inspection unit 160 may turn on the voltage switch 133 to supply the low voltage LV to the auxiliary relay 134, as shown in FIGS. 1 to 5, or may control the battery 120 to supply the low voltage LV to the auxiliary relay 134, as shown in FIGS. 6A and 6B.

When the low voltage LV is applied to the second coil portion CI2 of the auxiliary relay 134, the second junction portion CP2 of the auxiliary relay 134 is energized. When the second junction portion CP2 is energized in this way, the low voltage LV of one end of the second junction portion CP2 is applied to the first coil portion CI1 of the main relay 132. When the low voltage LV is applied to the first coil portion CI1, the first junction portion CP1 is energized. When the first junction portion CP1 is energized in this way, the stack voltage SV of one end of the first junction portion CP1 may be supplied to the COD heater 150.

After step 220, the COD heater 150 increases the temperature of the residual water generated from the fuel cell 110 (step 230).

After step 230, whether the increase in the temperature of the residual water is completed is determined (step 240). When it is determined that the increase in the temperature of the residual water has not been completed, the process proceeds to step 230 to continuously increase the temperature of the residual water. Alternatively, when it is determined that the increase in the temperature of the residual water has been completed, the low voltage is not applied to the second coil portion CI2 (step 250).

For example, when it is determined by the start-up inspection unit 160 that the increase in the temperature of the residual water has been completed, the voltage switch 133 is turned off or the battery 120 is controlled so that the low voltage LV is not applied to the auxiliary relay 134. When the low voltage LV is not applied to the second coil portion CI2 of the auxiliary relay 134, the second junction portion CP2 is not energized, and thus the low voltage LV is not applied to the first coil portion CI1. Accordingly, the first junction portion CP1 is not energized, so the stack voltage SV is not supplied to the COD heater 150.

Hereinafter, the fuel cell vehicle according to the embodiments is described in comparison with a comparative example.

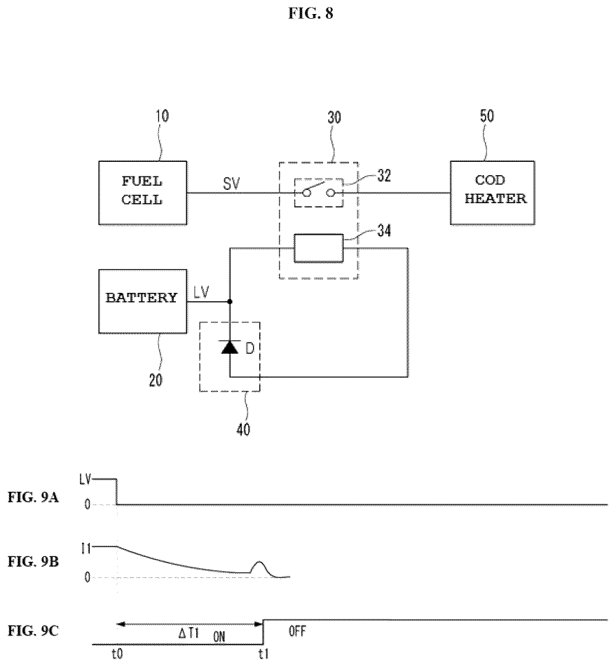

FIG. 8 is a block diagram of a fuel cell vehicle according to a comparative example.

The fuel cell vehicle according to the comparative example shown in FIG. 8 may include a fuel cell 10, a battery 20, a relay 30, a fuel cell control unit 40, and a COD heater 50.

The fuel cell 10, the battery 20, the relay 30, the fuel cell control unit 40, and the COD heater 50 shown in FIG. 8 may perform the same functions as the fuel cell 110, the battery 120, the main relay 130, the fuel cell control unit 140, and the COD heater 150 shown in FIG. 1, respectively.

In addition, the main relay 30 may include a coil portion 34 and a junction portion 32, similar to the main relay 132 shown in FIG. 2, and the fuel cell control unit 40 may include a diode D.

However, unlike the fuel cell vehicle according to the embodiment, the fuel cell vehicle according to the comparative example does not include the auxiliary relay 134.

Hereinafter, the methods of operating the fuel cell vehicle according to the comparative example and the fuel cell vehicle according to the embodiment configured as described above is described with reference to the accompanying drawings.

FIGS. 9A to 9C are waveform diagrams explaining the operation of the fuel cell vehicle according to the comparative example shown in FIG. 8. FIG. 9A is a waveform diagram of a voltage applied to the coil portion 34. FIG. 9B is a waveform diagram of a current flowing through the coil portion 34. FIG. 9C is a waveform diagram showing the contact state of the junction portion 32.

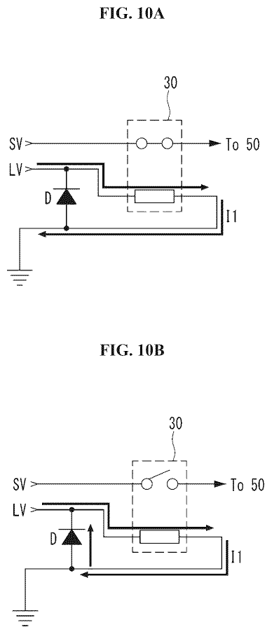

FIG. 10A is a diagram showing a state in which a current flows through the coil portion 34 when the junction portion 32 shown in FIG. 8 is in an on state. FIG. 10B is a diagram showing a state in which the junction portion 32 is turned off after the current flows through the coil portion 34 shown in FIG. 8 for a predetermined time period.

In the fuel cell vehicle according to the comparative example, when the low voltage LV is applied to the coil portion 34 and the current I1 flows through the coil portion 34 as shown in FIG. 10A, the junction portion 32 is turned on. In this case, when the low voltage LV is not applied to the coil portion 34 at a time point t0 as shown in FIG. 9A, the current I1 flowing through the coil portion 34 is reduced for a predetermined time period ΔT1 by the feedback circuit, i.e., the diode D, as shown in FIG. 9B. Thus, the junction portion 32 is not immediately turned off at the time point t0, but is turned off at a time point t1 after the time period ΔT1 during which the current flows through the coil portion 34, as shown in FIG. 10B.

In this way, according to the comparative example, a delay time ΔT1 during which the junction portion 32 is slowly turned off by the feedback circuit D (hereinafter referred to as an “opening delay time”) occurs from the time point t0 at which the low voltage LV is not applied to the coil portion 34 to the time point at which the junction portion 32 is actually turned off, so the performance of the relay 30 may deteriorate.

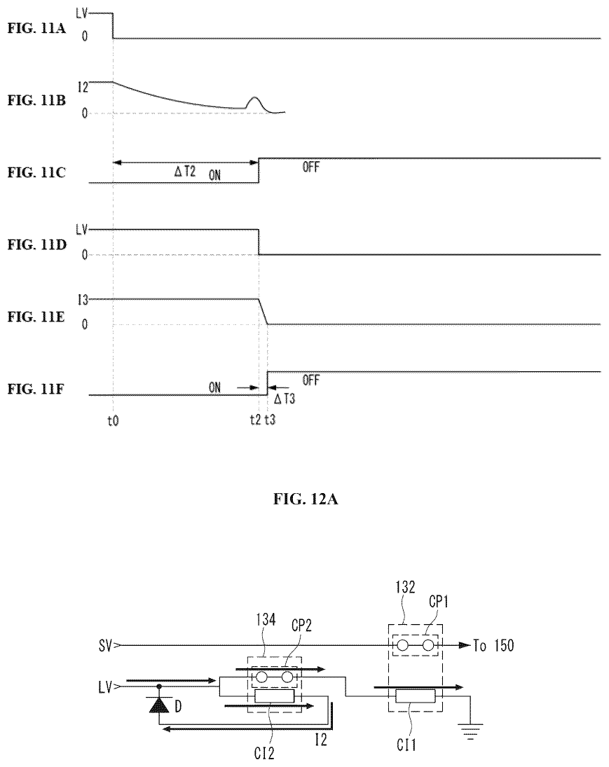

FIGS. 11A to 11F are waveform diagrams explaining the operation of the fuel cell vehicle according to the embodiment shown in FIG. 2. FIG. 11A is a waveform diagram of a voltage applied to the second coil portion CI2 of the auxiliary relay 134. FIG. 11B is a waveform diagram of a current flowing through the second coil portion CI2. FIG. 11C is a waveform diagram showing the contact state of the second junction portion CP2. FIG. 11D is a waveform diagram of a voltage applied to the first coil portion CI1 of the main relay 132. FIG. 11E is a waveform diagram of a current flowing through the first coil portion CI1. FIG. 11F is a waveform diagram showing the contact state of the first junction portion CP1.

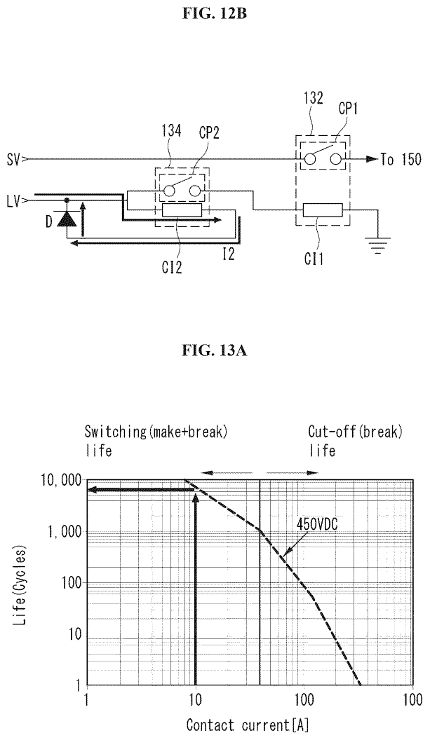

FIG. 12A is a diagram showing a state in which a current flows through the first and second coil portions CI1 and CI2 when the first and second junction portions CP1 and CP2 shown in FIG. 2 are in an on state. FIG. 12B is a diagram showing a state in which the first junction portion CP1 is turned off after the current flows through the second coil portion CI2 shown in FIG. 2 for a predetermined time period and then flows through the first coil portion CI1 for a predetermined time period.

In the fuel cell vehicle according to the embodiment, when the low voltage LV is applied to the second coil portion CI2 and the current I2 flows through the second coil portion CI2 as shown in FIG. 12A, the second junction portion CP2 is turned on. Additionally, when the low voltage LV is applied to the first coil portion CI1 and the current flows through the first coil portion CI1 through the turn-on of the second junction portion CP2, the first junction portion CP1 is turned on. In this case, when the low voltage LV is not applied to the second coil portion CI2 at a time point t0 as shown in FIG. 11A, the current I2 flowing through the second coil portion CI2 is reduced during a second delay time ΔT2, as shown in FIG. 11B. Thus, the second junction portion CP2 is not immediately turned off at the time point t0, but is turned off at a time point t2 after the second delay time ΔT2 during which the current flows through the second coil portion CI2, as shown in FIG. 12B. When the second junction portion CP2 is turned off in this way, the low voltage LV is not applied to the first coil portion CI1, as shown in FIG. 11D. When the low voltage LV is not applied to the first coil portion CI1 at the time point t2 as shown in FIG. 11D, the current I3 flowing through the first coil portion CI1 is reduced during a third delay time ΔT3, as shown in FIG. 11E. Thus, the first junction portion CP1 is not immediately turned off at the time point t2, but is turned off at a time point t3 after the third delay time ΔT3, as shown in FIG. 12B.

In this case, because the auxiliary relay 134 has a smaller capacity than the main relay 30 or 132, the operating speed thereof is relatively high, and thus, the second delay time ΔT2 is shorter than the first delay time ΔT1. For example, ΔT1 may be 40 milliseconds (ms), and ΔT2 may be 10 ms. Therefore, according to the embodiment, the auxiliary relay 134 may have a smaller capacity than the main relay 132.

Therefore, when ΔT3 is 5 ms, the total opening delay time ΔT1 in the comparative example is 40 ms, while the total opening delay time (ΔT2+ΔT3) in the embodiment may be reduced to 13 ms.

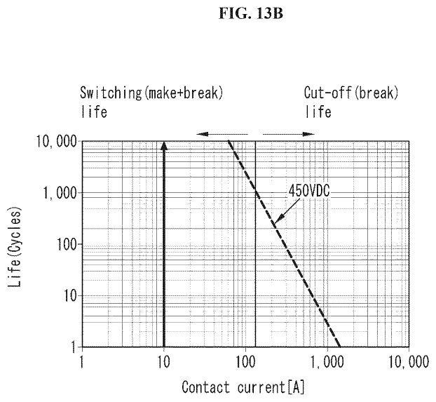

FIGS. 13A and 13B are graphs showing the number of switching operations based on the capacity of the relay, in which the horizontal axis represents contact current, and the vertical axis represents the number of switching operations (Life). “Make” means that the junction portion of the relay is turned on, and “break” means that the junction portion is turned off.

FIG. 13A shows the number of switching operations of a relay having a voltage rating of 500 volts and a current rating of 40 A. FIG. 13B shows the number of switching operations of a relay having a voltage rating of 500 volts and a current rating of 150 A.

When the relay is repeatedly switched on and off (switching=make+break), the relay is damaged, and thus, the number of uses thereof is limited.

When the capacity of the relay shown in FIG. 13A is increased to that of the relay shown in FIG. 13B, when a current of 10 A flows through the junction portion of the relay, it may be seen that the number of switching operations increases from 6,000 shown in FIG. 13A to 10,000 shown in FIG. 13B. In each graph, the dotted line indicates the performance of the relay, and the solid line indicates the number of switching operations.

In this way, when the capacity of the relay increases, the number of switching operations increases. However, when an opening delay time occurs as in the comparative example, the number of switching operations may not increase and the performance of the relay may deteriorate despite the increase in the capacity of the relay. For example, when the feedback circuit, i.e., the diode D, is not present, the opening delay time is 5 ms or shorter, and the number of switching operations is 12,000 or greater. In other words, the relay may operate normally. However, when the feedback circuit is present, the opening delay time increases 8-fold to about 40 ms, and the relay is fused six times. In other words, the number of switching operations is reduced.

In contrast, according to the embodiment, the auxiliary relay 134 is added to reduce the opening delay time occurring in the main relay 132 to 5 ms or shorter. Accordingly, the number of switching operations may be increased to, e.g., 12,000 or greater in accordance with the increase in the capacity of the main relay 132, thereby ensuring normal operation.

As a result, when the capacity of the main relay 30 or 132 is increased, the number of switching operations of the relay capable of cutting off current increases. However, the comparative example is not capable of exhibiting a switching number increasing effect due to the presence of the feedback circuit. In contrast, according to the embodiment, since the auxiliary relay 134 is disposed inside the power distribution unit, the capacity of the relay may be increased despite the presence of the feedback circuit, and accordingly, the number of switching operations of the relay may be increased.

In addition, according to the embodiment, since the auxiliary relay 134 is disposed inside the power distribution unit 130A to 130E and the first coil portion CI1 is grounded, the opening delay may be improved without adding a separate circuit, e.g., changing the configuration of the fuel cell control unit 140 or changing wirings outside the power distribution unit 130A to 130E.

In addition, according to the embodiment, after power-off of the fuel cell vehicle, the temperature of the residual water may be increased using the COD heater 150, thereby preventing quality deterioration caused by freezing of the residual water in the fuel cell vehicle in winter.

As it should be apparent from the above description, according to the fuel cell vehicle and the method of operating the same according to the embodiments, the capacity of the relay may be increased despite the presence of the feedback circuit. Accordingly, the number of switching operations of the relay may be increased. In addition, the opening delay may be improved without adding a separate circuit. In addition, after power-off of the fuel cell vehicle, the temperature of the residual water may be increased using the COD heater, thereby preventing quality deterioration caused by freezing of the residual water in the fuel cell vehicle in winter.

However, the effects achievable through the disclosure are not limited to the above-mentioned effects, and other effects not mentioned herein should be clearly understood by those having ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to exemplary embodiments thereof, these embodiments are only proposed for illustrative purposes, and do not restrict the present disclosure. Additionally, it should be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell vehicle, comprising:
a fuel cell configured to generate a stack voltage;
a battery configured to output a low voltage having a lower level than the stack voltage;
a cathode oxygen depletion (COD) heater configured to increase a temperature of residual water generated from the fuel cell in response to the stack voltage;
a power distribution unit configured to supply the stack voltage to the COD heater;
a fuel cell control unit including a diode having a cathode connected to the low voltage and an anode connected to the power distribution unit; and
a start-up inspection unit configured to determine whether to supply the low voltage to the COD heater based on a result of inspecting whether the fuel cell vehicle is powered off,
wherein the power distribution unit includes:
an auxiliary relay configured to be energized when the low voltage is applied thereto; and
a main relay configured to supply the stack voltage to the COD heater when the auxiliary relay is energized.

2. The fuel cell vehicle according to claim 1, wherein the main relay comprises:
a first junction portion disposed between the stack voltage and the COD heater; and
a first coil portion including a first end connected to the auxiliary relay and a second end connected to a reference potential,
wherein the auxiliary relay includes:
a second junction portion disposed between the low voltage and the first end of the first coil portion; and
a second coil portion disposed between the low voltage and the anode of the diode,
wherein the second junction portion is turned on when the low voltage is applied to the second coil portion, and
wherein, when the low voltage is applied to the first end of the first coil portion through the second junction portion, the first junction portion is energized to supply the stack voltage to the COD heater.

3. The fuel cell vehicle according to claim 2, further comprising a voltage switch including a first end connected to the battery and a second end connected to the second coil portion, the voltage switch being configured to connect the battery to the second end of the second coil portion in response to a control signal,
wherein the start-up inspection unit is configured to generate the control signal based on the result of inspecting whether the fuel cell vehicle is powered off.

4. The fuel cell vehicle according to claim 3, wherein the cathode of the diode is connected to the first end of the voltage switch.

5. The fuel cell vehicle according to claim 3, wherein the cathode of the diode is connected to the second end of the voltage switch.

6. The fuel cell vehicle according to claim 3, wherein the power distribution unit comprises the voltage switch.

7. The fuel cell vehicle according to claim 2, wherein the battery applies the low voltage to the second coil portion in response to a control signal, and
wherein the start-up inspection unit is configured to generate the control signal based on the result of inspecting whether the fuel cell vehicle is powered off.

8. The fuel cell vehicle according to claim 2, wherein the reference potential corresponds to a ground of a housing of the power distribution unit.

9. The fuel cell vehicle according to claim 2, wherein the reference potential corresponds to a ground of the fuel cell control unit.

10. The fuel cell vehicle according to claim 2, wherein the power distribution unit further comprises a pyro fuse disposed between the stack voltage and the first junction portion.

11. The fuel cell vehicle according to claim 2, wherein the power distribution unit further comprises an integrated relay connected between the stack voltage and each of an end cell heater and the first junction portion.

12. The fuel cell vehicle according to claim 2, wherein the COD heater comprises:
a resistor including a first end connected to a positive output terminal of the fuel cell; and
a switching element including a first end connected to a second end of the resistor and a second end connected to the first junction portion, and
wherein the first junction portion is connected between a negative output terminal of the fuel cell and the second end of the switching element.

13. The fuel cell vehicle according to claim 2, wherein the COD heater comprises:
first to N^{th} resistors connected in parallel to each other; and
first to N^{th} switching elements connected to the first to N^{th} resistors, respectively,
wherein the n^{th} resistor includes a first end connected to a positive output terminal of the fuel cell, and
wherein the n^{th} switching element is connected between a second end of the n^{th} resistor and the first junction portion.

14. A method of operating a fuel cell vehicle comprising a fuel cell configured to generate a stack voltage, a battery configured to output a low voltage having a lower level than the stack voltage, a cathode oxygen depletion (COD) heater, a power distribution unit including an auxiliary relay disposed between the low voltage and the COD heater and a main relay disposed between the auxiliary relay and the COD heater, and a fuel cell control unit including a diode having a cathode connected to the low voltage and a anode connected to the power distribution unit, the method comprising:
inspecting whether the fuel cell vehicle is powered off;
energizing the main relay the auxiliary relay to supply the stack voltage to the COD heater when it is determined that the fuel cell vehicle has been powered off; and
increasing a temperature of residual water generated from the fuel cell when the stack voltage is supplied.

15. The method according to claim 14, wherein the main relay comprises:
a first junction portion disposed between the stack voltage and the COD heater; and
a first coil portion including a first end connected to the auxiliary relay and a second end connected to a reference potential,
wherein the auxiliary relay includes:
a second junction portion disposed between the low voltage and the first end of the first coil portion; and
a second coil portion disposed between the low voltage and the anode of the diode, and
wherein supplying the stack voltage includes:
applying the low voltage to the second coil portion to energize the second junction portion when it is determined that the fuel cell vehicle has been powered off; and
energizing the first junction portion to supply the stack voltage to the COD heater when the low voltage is applied to the first coil portion through energization of the second junction portion.

16. The method according to claim 15, further comprising:
not applying the low voltage to the second coil portion upon completion of the residual water heating.

17. The method according to claim 15, further comprising determining, via a start-up inspection unit of the fuel cell vehicle, whether to supply the low voltage to the COD heater based on a result of inspecting whether the fuel cell vehicle is powered off.

18. The method according to claim 17, further comprising:
connecting, via a voltage switch, the battery to a second end of the second coil portion in response to a control signal, the voltage switch including a first end connected to the battery and a second end connected to the second coil portion; and
generating, via the start-up inspection unit, the control signal based on the result of inspecting whether the fuel cell vehicle is powered off.

19. The method according to claim 18, wherein the cathode of the diode is connected to the first end of the voltage switch.

20. The method according to claim 18, wherein the cathode of the diode is connected to the second end of the voltage switch.
